(19) United States
(12) Patent Application Publication
(10) Pub. No.: US 2014/0010966 A1
(43) Pub. Date: Jan. 9, 2014

(54) AQUEOUS COATING MATERIAL AND METHOD OF FORMING SMOOTH ARTICLE

(71) Applicant: Wistron Corporation, New Taipei City (TW)

(72) Inventor: Li-Sheng Teng, New Taipei City (TW)

(73) Assignee: Wistron Corporation, New Taipei City (TW)

(21) Appl. No.: 13/902,987

(22) Filed: May 28, 2013

(30) Foreign Application Priority Data
Jul. 9, 2012 (TW) 101124638

(51) Int. Cl. C09D 7/00

(52) U.S. Cl. CPC C09D 7/001
USPC 427/385.5; 524/556; 524/377; 524/375

(57) ABSTRACT

An aqueous coating material is provided. The aqueous coating material includes an aqueous acrylic resin having OH group, an aqueous hardener agent having NCO group, a color paste, a functional auxiliary agent, a film-formation auxiliary agent, and a diluent. A percent by weight of the aqueous acrylic resin having the OH group is 40-65 wt %. A percent by weight of the aqueous hardener agent having the NCO group is 10-18 wt %. A percent by weight of the color paste is 6-15 wt %. A percent by weight of the functional auxiliary agent is 0.5-3 wt %. A percent by weight of the film-formation auxiliary agent is 8-20 wt %. A percent by weight of the diluent is 10.5-35 wt %. An equivalent ratio of the NCO group to the OH group ranges from 0.95 to 1.6.

### CROSS-REFERENCE TO RELATED APPLICATION

This application claims the priority benefit of Taiwan application serial no. 101124638, filed on Jul. 9, 2012. The entirety of the above-mentioned patent application is hereby incorporated by reference herein and made a part of this specification.

### BACKGROUND OF THE INVENTION

1. Field of Invention

The invention relates to a coating material and a method of forming an article. More particularly, the invention relates to an aqueous coating material and a method of forming an article having a smooth surface.

2. Background of the Invention

At present, 3C products on the market are often designed to be light, slim, and compact. At the beginning, casings of normal 3C products are often made of metal materials, but engineering plastic materials then replace the metal materials that are not cost-effective. After numerous test and comparison procedures, it is found that the relatively appropriate engineering plastic material includes nylon containing a great amount (approximately 50%) of glass fibers. However, when the nylon material containing a great amount of glass fibers is applied in an injection process, uneven arrangement of the glass fibers may deface the exterior of the 3C products. Hence, to cover the unevenly arranged fibers and smooth the exterior of the 3C products, a coating material is frequently applied to perform surface treatment.

In the existing surface smoothing process, a solvent-type coating material is often utilized for performing a coating process to form a bonding bottom layer and a functional top layer. The functional top layer, for instance, serves to cover the flawed appearance of an article and smooth the surface of the article. The solvent-type coating material, however, necessitates the use of a volatile organic solvent, which may be detrimental to environmental protection. Besides, in the conventional surface smoothing process, the coating steps are required to be performed at least twice to coat two layers, thus complicating the overall process. Moreover, to prevent the article from being deformed during a baking process, the temperature at which the coating material is dried needs to be set low.

### SUMMARY OF THE INVENTION

The invention is directed to an aqueous coating material that may achieve a bonding effect and cover unevenly arranged fibers.

The invention is further directed to a method of forming an article having a smooth surface, and the method contains simple steps.

In an embodiment of the invention, an aqueous coating material is provided. The aqueous coating material includes an aqueous acrylic resin having OH group, an aqueous hardener agent having NCO group, a color paste, a functional auxiliary agent, a film-formation auxiliary agent, and a diluent. A percent by weight of the aqueous acrylic resin having the OH group ranges from about 40 wt % to about 65 wt %. A percent by weight of the aqueous hardener agent having the NCO group ranges from about 10 wt % to about 18 wt %. A percent by weight of the color paste ranges from about 6 wt % to about 15 wt %. A percent by weight of the functional auxiliary agent ranges from about 0.5 wt % to about 3 wt %. A percent by weight of the film-formation auxiliary agent ranges from about 8 wt % to about 20 wt %. A percent by weight of the diluent ranges from about 10.5 wt % to about 35 wt %. An equivalent ratio of the NCO group to the OH group ranges from about 0.95 to about 1.6.

In an embodiment of the invention, a method of forming an article having a smooth surface is provided, and the method includes following steps. A color paste, a functional auxiliary agent, a film-formation auxiliary agent, and a diluent are mixed to form a first solution. An aqueous hardener agent having NCO group is added into the first solution to form a second solution. An aqueous acrylic resin having OH group is added into the second solution to form an aqueous coating material, and an equivalent ratio of the NCO group to the OH group ranges from about 0.95 to about 1.6. The aqueous coating material is spray-coated onto a surface of an article. The aqueous coating material is dried, such that the article has a smooth surface.

In view of the above, the aqueous coating material described herein is a water-soluble coating material; therefore, the use of a volatile organic solvent is not needed, and the requirement for environmental protection may be satisfied. Besides, the aqueous coating material described herein may simultaneously achieve a bonding effect and cover unevenly arranged fibers. From another perspective, in the method of forming the article having the smooth surface described herein, the aforesaid aqueous coating material is employed. As a result, the method of forming the article having the smooth is simple, and the resultant article with the smooth surface may have satisfactory exterior design.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A through FIG. 1D are schematic diagrams showing a method of forming an article having a smooth surface according to an embodiment of the invention.

FIG. 2 is a schematic flow chart illustrating a method of forming an article having a smooth surface according to an embodiment of the invention.

### DETAILED DESCRIPTION OF DISCLOSED EXEMPLARY EMBODIMENTS

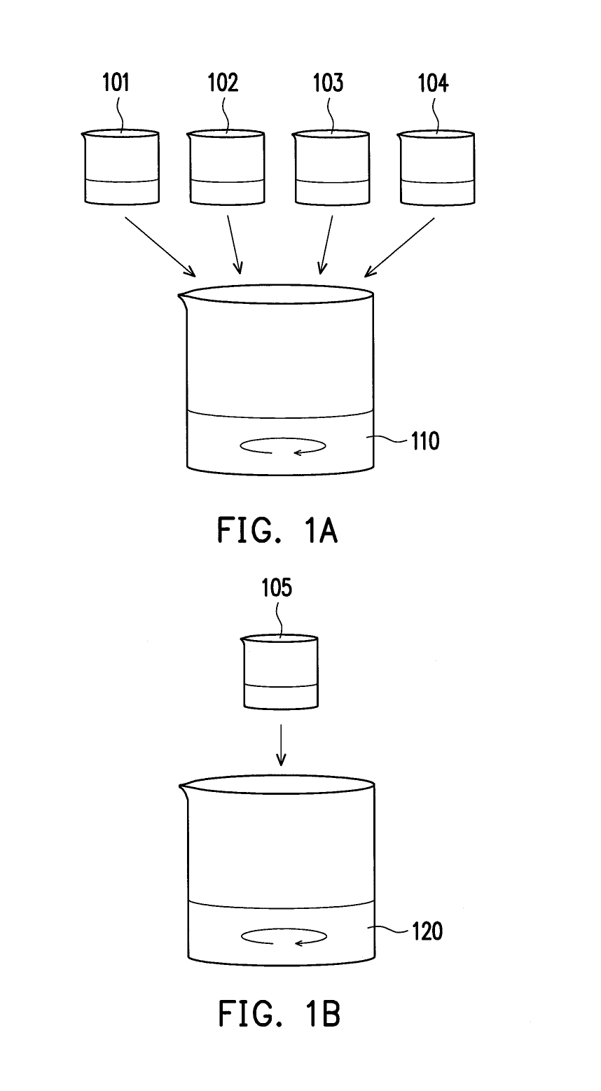

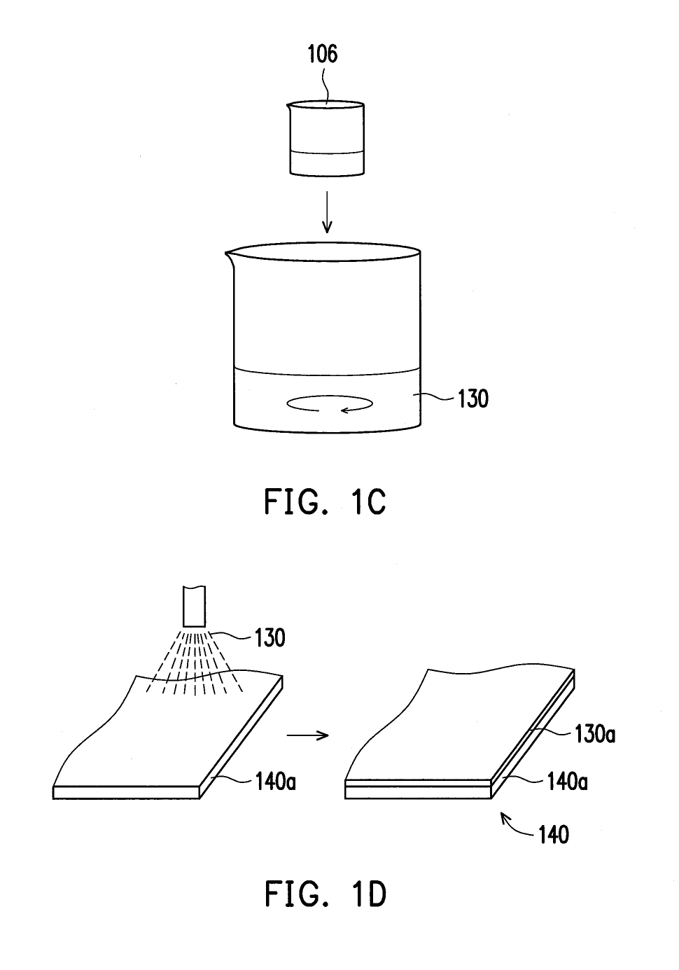

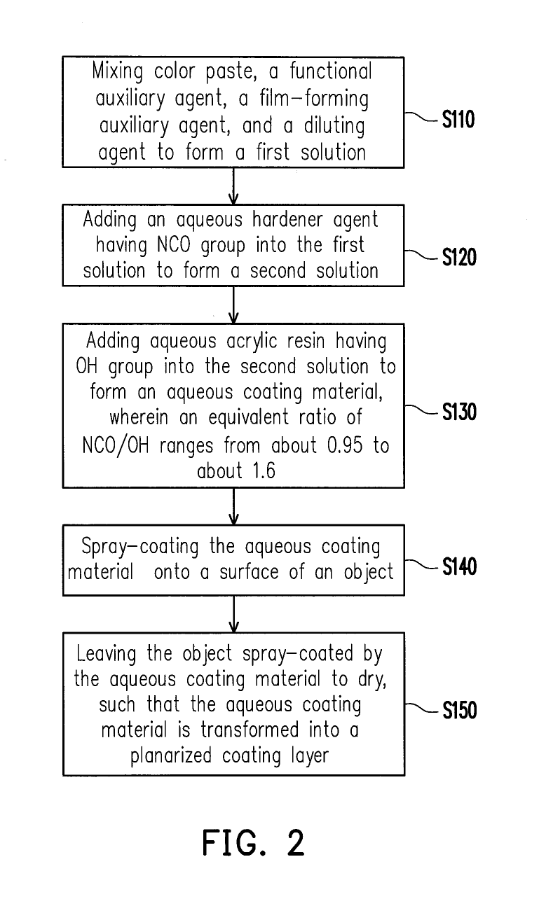

FIG. 1A through FIG. 1D are schematic diagrams showing a method of forming an article having a smooth surface according to an embodiment of the invention. FIG. 2 is a schematic flow chart illustrating a method of forming an article having a smooth surface according to an embodiment of the invention. With reference to FIG. 1A and FIG. 2, an aqueous coating material 130 is prepared. In step S110, a color paste 101, a functional auxiliary agent 102, a film-formation auxiliary agent 103, and a diluent 104 are mixed and stirred for 10˜15 minutes to form a first solution 110. Note that the order of adding each ingredient is not limited in the present embodiment; namely, the color paste 101, the functional auxiliary agent 102, the film-formation auxiliary agent 103, and the diluent 104 may be mixed at the same time or not, and then these solutions are stirred to form the first solution 110.

With reference to FIG. 1B and FIG. 2, in step S120, an aqueous hardener agent 105 having NCO group is added into the first solution 110 to form a second solution 120. As shown in FIG. 1C and FIG. 2, in step S130, an aqueous acrylic resin 106 having OH group is added into the second solution 120. The mixed second solution 120 is stirred for about 30-45 minutes to form an aqueous coating material 130. In the present embodiment, the amount of the aqueous acrylic resin 106 having the OH group is relatively large. Hence, to evenly mix each ingredient of the aqueous coating material 130, the aqueous hardener agent 105 having the NCO group may be added to the first solution 110, and the mixed first solution 110 is stirred to form the second solution 120. The aqueous acrylic resin 106 having the OH group is then added to the well-stirred solution. Besides, each ingredient may be better mixed through mechanical stirring.

In the aqueous coating material 130, the percent by weight of the color paste 101 in total weight of the aqueous coating material 130 ranges from about 6 wt % to about 15 wt %, the percent by weight of the functional auxiliary agent 102 in total weight of the aqueous coating material 130 ranges from about 0.5 wt % to about 3 wt %, and the percent by weight of the film-formation auxiliary agent 103 in total weight of the aqueous coating material 130 ranges from about 8 wt % to about 20 wt %, for instance. The percent by weight of the diluent 104 n total weight of the aqueous coating material 130 ranges from about 10.5 wt % to about 35 wt %, the percent by weight of the aqueous hardener agent 105 having the NCO group in total weight of the aqueous coating material 130 ranges from about 10 wt % to about 18 wt %, and the percent by weight of the aqueous acrylic resin 106 having the OH group in total weight of the aqueous coating material 130 ranges from about 10 wt % to about 18 wt %, for instance. In the present embodiment, an equivalent ratio of the NCO group to the OH group ranges from about 0.95 to about 1.6.

Besides, an average molecular weight of the aqueous hardener agent 105 having the NCO group ranges from about 14500 to about 15500 in the present embodiment, and the aqueous hardener agent 105 is conducive to the hardening of the aqueous coating material 130. The type of the aqueous hardener agent 105 having the NCO group may be determined based on the type of the aqueous acrylic resin 106 having the OH group.

An average molecular weight of the aqueous acrylic resin 106 having the OH group ranges from about 3500 to about 4500, and the aqueous acrylic resin 106 having the OH group ensures the aqueous coating material 130 to have favorable bonding properties.

In the present embodiment, an average diameter of particles of the color paste 101 ranges from about 500 nm to about 1.2 μm, and a color of the color paste 101 is a dark color. Particularly, the aqueous coating material 130 including the color paste 101 is coated onto the substrate, and the dried aqueous coating material 130 is transformed into a smooth coating layer having a dry-film thickness. When the dry-film thickness is greater than 14 μm, the light transmittance is substantially zero. The dark color is black, gray, brown, dark brown, dark blue, or any other appropriate color, for instance. In the present embodiment, the color paste 101 is black, for instance, and an average diameter of the particles of the color paste 101 ranges from about 800 nm to about 1 μm. As a result, the aqueous coating material 130 may provide a satisfactory coverage function.

According to the present embodiment, the functional auxiliary agent 102 includes a defoamer, a slip and leveling agent, or a dispersant. The defoamer may serve to eliminate foam generated in the process of forming the aqueous coating material 130. The slip and leveling agent may ensure the leveling of the aqueous coating material 130 during the film formation. The dispersant may reduce interfacial tension among each ingredient, such that each ingredient may be uniformly mixed to form the aqueous coating material 130.

In the present embodiment, the film-formation auxiliary agent 103 is a cosolvent, such as ether alcohol, acid ester, or a combination thereof, for instance. The film-formation auxiliary agent 103 may help the aqueous acrylic resin 106 having the OH group uniformly mixed with other ingredients, such that the aqueous coating material 130 is able to be transformed into a film layer. Here, the film-formation auxiliary agent 103 is, for instance, dipropylene glycol normal butyl ether (DPNB), ethylene glycol monobutylether, or propylene glycol phenyl ether. It is likely to use TEXANOL (Eastman Kodak), Butyl diglyco Butyl glyco EFC-200 (Cognis), or EFC-300 (Cognis) on the market as the film-formation auxiliary agent 103 described herein.

According to the present embodiment, the diluent 104 serves to adjust viscosity of the aqueous coating material 130, for instance. The diluent 104 described herein is water, for instance. Different aqueous acrylic resin 106 having the OH group may have different amount of water, which may further affect the viscosity of the aqueous coating material 130. Therefore, the overall viscosity of the aqueous coating material 130 may be adjusted by additionally adding the diluent 104 to the aqueous coating material 130. The viscosity of the aqueous coating material 130 measured by using Ford Cup is 11˜11.5 seconds.

With reference to FIG. 1D and FIG. 2, in step S140, the aqueous coating material 130 is spray-coated onto a surface of an article 140a. The article 140a includes a plastic casing of a 3C product, and the plastic casing may be made of acrylonitrile butadiene styrene (ABS), polycarbonate (PC), polyamide (PA), or polyphthal amide (PPA), for instance. When the article 140a is made of plastic containing glass fibers, for instance, the unevenly arranged fibers on the surface of the article 140a may deface the exterior of the article 140a.

In step S150, the article 140a on which the aqueous coating material 130 is spray-coated is dried, such that the aqueous coating material 130 is transformed into a smooth coating layer 30a. So far, the article 140 with the smooth surface is completely formed.

A method of drying the aqueous coating material 130 may include baking the aqueous coating material 130 at a low baking temperature to evaporate moisture therein. The baking temperature is lower than 75° C., for instance, and the time spent on baking is about 30 minutes. Here, the baking temperature may be adjusted based on the type of the article spray-coated by the aqueous coating material 130. The baked aqueous coating material 130 is dried for 2-3 days, such that the aqueous coating material 130 may be transformed into a smooth coating layer 30a. In the present embodiment, the baking temperature is lower than 60° C., for instance. However, the invention is not limited thereto, and the method of drying the aqueous coating material 130 in another embodiment of the invention may include drying the aqueous coating material 130 at the room temperature (25° C.) for 5-7 days, so as to form the smooth coating layer 30a. Since the aqueous coating material 130 described herein is dried on a low-temperature condition, the article is rather not apt to be deformed due to implementation of a high-temperature baking process.

The smooth coating layer 30a made of the aqueous coating material 130 described herein has a thickness ranging from about 16 μm to about 25 μm, for instance. Owing to the small thickness, the smooth coating layer 30a is suitable for being applied onto the surface of a variety of articles without increasing the overall thickness. That is, the aqueous coating material 130 described in the present embodiment is applicable to articles with slim and compact exterior design.

Note that the aqueous coating material 130 described in the present embodiment may simultaneously achieve a bonding effect and cover unevenly arranged fibers. Hence, in comparison with the conventional solvent-type coating material which is often utilized for performing a coating step twice to respectively coat two layers, the aqueous coating material 130 described in the present embodiment may be transformed into one coating layer, so as to complete the fabrication of the smooth article 140. As a result, the manufacturing process may be simplified, and the time spent on the manufacturing process may be reduced.

Property Tests of Aqueous Coating Material

### Example 1

7 g of a black color paste, 0.7 g of a functional auxiliary agent, 9 g of a film-formation auxiliary agent, and 15.3 g of water are mixed and mechanically stirred for 25 minutes. 13 g of an aqueous hardener agent and 55 g of an aqueous acrylic resin are sequentially added to the stirred solution, and the mixture is then mechanically stirred for 40 minutes. Here, the equivalent ratio of the NCO group to the OH group is about 1.4. The mixture is left at the room temperature until foam or air bubbles disappear, and the resultant aqueous coating material is spray-coated onto an article made of polyamide (PA) containing 50% of glass fibers. A baking process is performed at 65° C., and the baked article is left for 72 hours. The dry-film thickness is 22 μm. Relevant property tests are then performed.

### Example 2

10 g of the black color paste, 1 g of the functional auxiliary agent, 8 g of the film-formation auxiliary agent, and 20 g of water are mixed and mechanically stirred for 25 minutes. 10 g of the aqueous hardener agent and 55 g of the aqueous acrylic resin are sequentially added to the stirred solution, and the mixture is then mechanically stirred for 35 minutes. Here, the equivalent ratio of the NCO group to the OH group is about 1.2. The mixture is left at the room temperature until foam or air bubbles disappear, and the resultant aqueous coating material is spray-coated onto an article made of polyamide (PA) containing 50% of glass fibers. A baking process is performed at 60° C., and the baked article is left for 72 hours. The dry-film thickness is 19 μm. Relevant property tests are then performed.

### Example 3

12 g of the black color paste, 1.2 g of the functional auxiliary agent, 9 g of the film-formation auxiliary agent, and 15 g of water are mixed and mechanically stirred for 30 minutes. 7.8 g of the aqueous hardener agent and 55 g of the aqueous acrylic resin are sequentially added to the stirred solution, and the mixture is then mechanically stirred for 30 minutes. Here, the equivalent ratio of the NCO group to the OH group is about 0.95. The mixture is left at the room temperature until foam or air bubbles disappear, and the resultant aqueous coating material is spray-coated onto an article made of polyamide (PA) containing 50% of glass fibers. A baking process is performed at 65° C., and the baked article is left for 72 hours. The dry-film thickness is 17 μm. Relevant property tests are then performed.

In light of the examples 1, 2 and 3, alcohol resistance test, MEK resistance test, and bonding stability test are performed. Note that the equivalent ratios of NCO/OH described in the examples 1, 2 and 3 are different from one another.

TABLE 1

| | Example 1 | Example 2 | Example 3 |
|---|---|---|---|
| NCO/OH | 1.4 | 1.2 | 0.95 |
| 80 g-load Alcohol | >50 | >50 | >50 |
| Resistance Test | | | |
| 80 g-load MEK | <16 | <10 | <8 |
| Resistance Test | | | |
| Bonding Stability | normal | normal | good |

According to Table 1, the higher the equivalent ratio of NCO/OH is, the larger the relative amount of the aqueous hardener agent having the NCO group is. This leads to the favorable chemical resistance property (obtained from the alcohol resistance test and the MEK resistance test) of the aqueous coating material. By contrast, the lower the equivalent ratio of NCO/OH is, the larger the relative amount of the aqueous acrylic resin having the OH group is. This leads to favorable bonding stability. Accordingly, users may, based on different requirements, apply the aqueous coating materials with different equivalent ratios of NCO/OH.

To sum up, the aqueous coating material described herein is a water-soluble coating material; therefore, the use of a volatile organic solvent is not needed, and the requirement for environmental protection may be satisfied. Moreover, the aqueous coating material described herein may simultaneously accomplish a bonding effect and cover unevenly arranged fibers. Hence, when the aqueous coating material is applied to make a smooth article, the manufacturing process may be simplified, and the time spent on the manufacturing process may be reduced. Additionally, the aqueous coating material described herein may be left to dry and may then be formed into a film layer on a low-temperature condition, and therefore the article is rather not apt to be deformed.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An aqueous coating material comprising:
an aqueous acrylic resin having OH group, wherein a percent by weight of the aqueous acrylic resin having the OH group ranges from 40 wt % to 65 wt %;
an aqueous hardener agent having NCO group, wherein a percent by weight of the aqueous hardener agent having the NCO group ranges from 10 wt % to 18 wt %;
a color paste, wherein a percent by weight of the color paste ranges from 6 wt % to 15 wt %;
a functional auxiliary agent, wherein a percent by weight of the functional auxiliary agent ranges from 0.5 wt % to 3 wt %;
a film-formation auxiliary agent, wherein a percent by weight of the film-formation auxiliary agent ranges from 8 wt % to 20 wt %; and
a diluent, wherein a percent by weight of the diluent ranges from 10.5 wt % to 35 wt %,
wherein an equivalent ratio of the NCO group to the OH group ranges from 0.95 to 1.6.

2. The aqueous coating material as recited in claim 1, wherein an average molecular weight of the aqueous acrylic resin having the OH group ranges from 3500 to 4500.

3. The aqueous coating material as recited in claim 1, wherein an average molecular weight of the aqueous hardener agent having the NCO group ranges from 14500 to 15500.

4. The aqueous coating material as recited in claim 1, wherein an average diameter of particles of the color paste ranges from 500 nm to 1.2 μm.

5. The aqueous coating material as recited in claim 1, wherein an average diameter of particles of the color paste ranges from 800 nm to 1 μm.

6. The aqueous coating material as recited in claim 1, wherein a color of the color paste is a dark color, and the aqueous coating material has a dry-film thickness greater than 14 μm.

7. The aqueous coating material as recited in claim 6, wherein the dark color is black, gray, brown, dark brown, or dark blue.

8. The aqueous coating material as recited in claim 1, wherein the functional auxiliary agent comprises a defoamer, a slip and leveling agent, or a dispersant.

9. The aqueous coating material as recited in claim 1, wherein the film-formation auxiliary agent comprises dipropylene glycol normal butyl ether, ethylene glycol monobutylether, or propylene glycol phenyl ether.

10. The aqueous coating material as recited in claim 1, wherein the diluent is water.

11. The aqueous coating material as recited in claim 1, wherein an average molecular weight of the aqueous acrylic resin having the OH group ranges from 3500 to 4500, an average molecular weight of the aqueous hardener agent having the NCO group ranges from 14500 to 15500, an average diameter of the color paste ranges from 500 nm to 1.2 μm, the functional auxiliary agent comprises a defoamer, a slip and leveling agent, or a dispersant, and the film-formation auxiliary agent comprises dipropylene glycol normal butyl ether, ethylene glycol monobutylether, or propylene glycol phenyl ether.

12. A method of manufacturing an aqueous coating material, comprising:
mixing a color paste, a functional auxiliary agent, a film-formation auxiliary agent, and a diluent to form a first solution;
adding an aqueous hardener agent having NCO group into the first solution to form a second solution; and
adding aqueous acrylic resin having OH group into the second solution to form the aqueous coating material, wherein an equivalent ratio of the NCO group to the OH group ranges from 0.95 to 1.6.

13. The aqueous coating material as recited in claim 12, wherein the diluent is water.

14. A method of forming an article having a smooth surface, comprising:
mixing a color paste, a functional auxiliary agent, a film-formation auxiliary agent, and a diluent to form a first solution;
adding an aqueous hardener agent having NCO group into the first solution to form a second solution;
adding aqueous acrylic resin having OH group into the second solution to form an aqueous coating material, wherein an equivalent ratio of the NCO group to the OH group ranges from 0.95 to 1.6;
spraying the aqueous coating material onto a surface of the article; and
drying the aqueous coating material, such that the aqueous coating material is transformed into a smooth coating layer.

15. The method as recited in claim 14, wherein the diluent is water.

16. The method as recited in claim 14, wherein a method of drying the aqueous coating material comprises:
baking the aqueous coating material at a low baking temperature so as to dry the aqueous coating material, wherein the baking temperature is lower than 75° C.

17. The method as recited in claim 14, wherein a method of drying the aqueous coating material comprises:
baking the aqueous coating material at a low baking temperature for a period of time, wherein the period of time ranges from 2 days to 3 days, and the baking temperature is lower than 60° C.

18. The method as recited in claim 14, wherein a method of drying the aqueous coating material comprises:
drying the aqueous coating material at a room temperature for a period of time, wherein the period of time ranges from 5 days to 7 days.

19. The method as recited in claim 14, wherein a thickness of the smooth coating layer ranges from 16 μm to 25 μm.
